(19) United States
(12) Patent Application Publication
(10) Pub. No.: US 2006/0213114 A1
(43) Pub. Date: Sep. 28, 2006

(54) Float with adjustable buoyancy

(76) Inventor: Krister Kumlin, Svanskog (SE)

Correspondence Address: NIXON & VANDERHYE, PC, 901 NORTH GLEBE ROAD, 11TH FLOOR, ARLINGTON, VA, 22203, US

(21) Appl. No.: 10/551,897

(22) PCT Filed: Mar. 26, 2004
(86) PCT No.: PCT/SE04/00463

§ 371 Date: Oct. 4, 2005

(30) Foreign Application Priority Data
Apr. 4, 2003 (SE) 0300980-0

(51) Int. Cl. A01K 93/00

(52) U.S. Cl. 43/43.14; 43/44.87

(57) ABSTRACT

A float including at least two structural members, enclosing a cavity having a volume which is variable by means of a relative movement of the structural members, said relative movement resulting in a change of the buoyancy of the float. According to the invention, the float includes a volume which is intended to be filled with water through an opening when the float is immersed in water, as well as an evacuating duct through which air is intended to flow out of the volume when the water flows in through the opening.

The invention relates to a float including at least two structural members, enclosing a cavity having a volume which is variable by means of a relative movement of the structural members, said relative movement resulting in a change of the buoyancy of the float.

The invention especially relates to a float for use when angling with a fishing rod and line.

U.S. Pat. No. 4,202,128 describes a fishing-tackle capable of functioning as a float of the above-mentioned type. The fishing-tackle consists of two members, which are movably connected to each other by means of a threaded coupling. The members enclose an air-filled cavity. The volume of the cavity is variable by means of a rotary motion of the members in relation to each other, said rotary motion resulting in a change of the buoyancy of the fishing-tackle. The fishing-tackle according to U.S. Pat. No. 4,202,128, however, exhibits the disadvantage of being relatively sensitive to wind and wave movements when it is utilised as a float.

The object of the present invention is to provide a float which at least partially eliminates this disadvantage, said float exhibiting a design resulting in a very good stability of the float and enabling a very accurate adjustment of the buoyancy of the float.

The invention is characterized in that the float includes a volume which is intended to be filled with water through an opening when the float is immersed in water, as well as an evacuating duct through which air is intended to flow out of the volume when the water flows in through the opening.

In the following, the invention will be described in greater detail with reference to the Figures.

FIG. 1 shows a sectional view of a first structural member of a float according to a first embodiment of the invention.

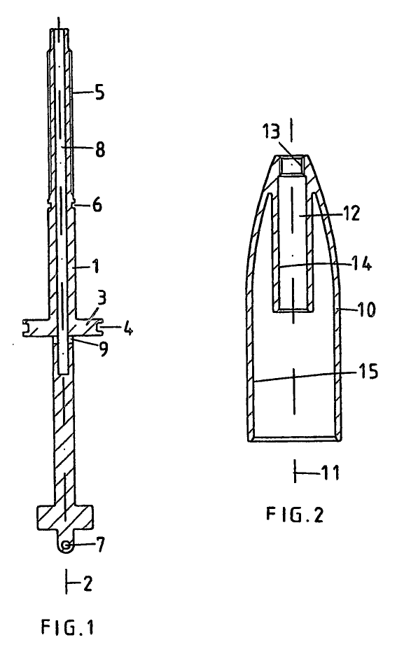

FIG. 2 shows a sectional view of a second structural member of a float according to the first embodiment.

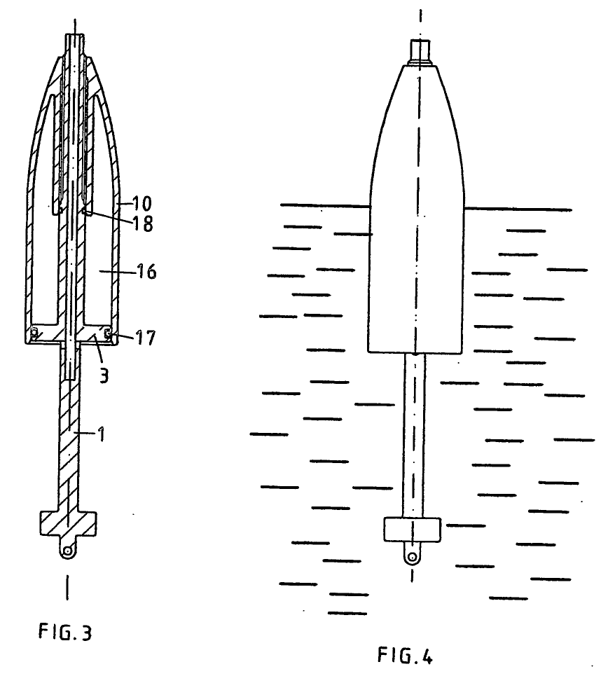

FIG. 3 shows a sectional view of a float according to the first embodiment having been adjusted into an extreme position where the float exhibits a maximum buoyancy.

FIG. 4 shows the float according to FIG. 3 when immersed in water.

FIG. 5 shows a sectional view of a float according to the first embodiment having been adjusted into an extreme position where the float exhibits a minimum buoyancy.

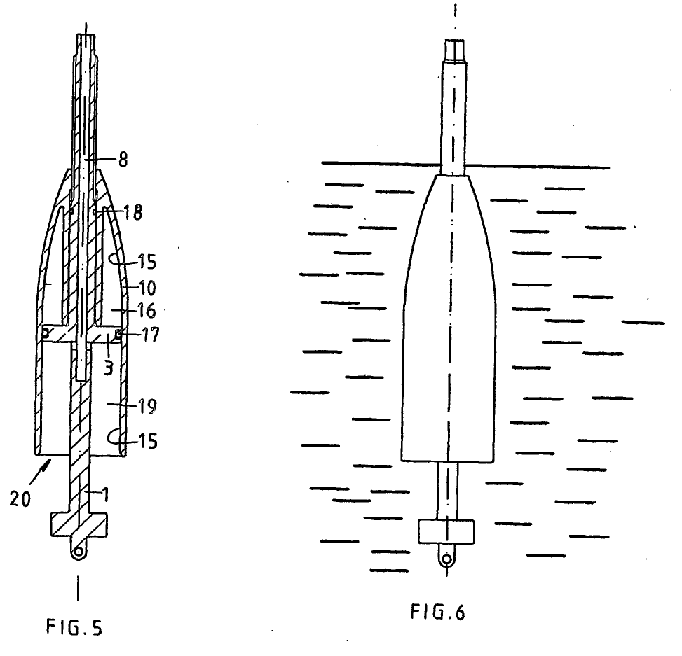

FIG. 6 shows the float according to FIG. 5 when immersed in water.

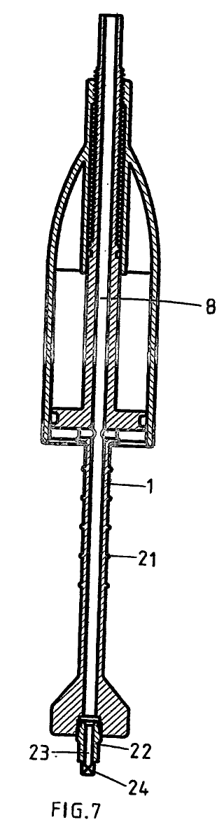

FIG. 7 shows a sectional view of a second embodiment of a float according to the invention.

FIG. 1 shows a first structural member 1 of a float according to a first embodiment of the invention. The structural member 1 has an elongated shape and is substantially rotationally symmetrical around a symmetry axis 2. At its central portion, the structural member 1 exhibits a flange 3, projecting radially in relation to the symmetry axis 2. The flange 3, in its turn, exhibits an external groove 4, extending in a circumferential direction around the flange 3. At an upper one of its ends, the structural member 1 exhibits an external thread groove 5, extending around approximately one third of the length of the structural member 1. Just below the thread groove 5, the structural member 1 exhibits an external groove 6, extending around the structural member 1 in a circumferential direction. At its other, lower end, the structural member 1 exhibits a through-eye 7 for the reception of a fishing line. The structural member 1 further exhibits an axial duct 8, extending from the upper end of the structural member 1 to just below the flange 3 where the duct 8 meets a transversal passage 9, ending just below the flange 3.

FIG. 2 shows a second structural member 10 of the float according to the first embodiment of the invention. The structural member 10 is bell-shaped and is substantially rotationally symmetrical around a symmetry axis 11. At a first one of its ends, the structural member 10 exhibits a through-duct 12, extending through approximately half the length of the structural member 10. At its upper end, the duct 12 exhibits an internal thread groove 13 for interaction with the thread groove 5 of the first structural member 1. Below the thread groove 13, the duct 12 exhibits an internal, circularly cylindrical surface 14, and below the lower orifice of the duct 12, the structural member 10 exhibits an internal surface 15, being cone-shaped at its upper portion and circularly cylindrical at its lower portion.

In order to create a finished float, the first structural member 1 is arranged in the second structural member 10, so that a threaded engagement is formed between the thread grooves 5 and 13, wherein the symmetry axes 2, 11 of the structural members coincide and constitute the symmetry axis of the float, as illustrated in FIGS. 3 and 5. Thereby, the structural members 1 and 10 enclose an air-filled cavity 16, being delimited by the flange 3 in a downward direction and by the second structural member 10 in an upward and radial direction. The float includes a first sealing 17 and a second sealing 18, being arranged in the grooves 4 and 6, respectively, in order to prevent water from penetrating into the cavity 16 when the float is used.

By means of rotary motion of the first structural member 1 in relation to the second structural member 10, the float can be adjusted between a first extreme position, as illustrated in FIG. 3, and a second extreme position, as illustrated in FIG. 5. In the first extreme position, the cavity 16 has a relatively large volume and the float has a relatively large displacement. In the second extreme position, the cavity 16 has a relatively small volume and the float has a relatively small displacement. Since the weight of the float is the same in the first extreme position as in the second extreme position, the float has a larger buoyancy in the first extreme position than in the second extreme position. This is evident from FIGS. 4 and 6, showing the float in the two extreme positions when immersed in water.

According to the invention, in the second extreme position and in positions between said extreme positions, the float exhibits a stabilizing volume 19 which is intended to be filled with water when using the float. The volume 19 is delimited by the flange 3 in an upward direction and by the internal surface 15 of the second structural member 10 in a radial direction. In a downward direction, the volume is open by means of an opening 20 in order to allow water to flow into the volume 19 when the float is immersed in water. In order to ensure that the entire volume 19 is filled with water and that no air remains within the volume 19, the float includes an evacuating duct through which air can flow out of the volume 19 when water flows in through the opening 20. In the shown embodiment, the evacuating duct is formed by said duct 8 and passage 9. Since the evacuating duct thereby extends from the upper end of the float to the upper portion of the volume 19, it is ensured that the evacuating duct opens into open air and that no air pockets can be formed within the volume 19. In the shown embodiment, the evacuating duct and the volume 19 are arranged substantially rotationally symmetrical around the symmetry axis of the float, something which provides for a well-balanced float.

By means of different selections of materials and dimensions, different buoyancy intervals can be obtained for the float. For example, the float can be made of glass fibre-reinforced acetal plastic, having a density of about 1.6 g/cm³, and with a cavity whose volume is variable so that the float obtains a buoyancy interval corresponding to sinker weights from about 0 to about 10 grams. It will be appreciated, however, that other materials and dimensions can be selected, whereby other buoyancy intervals can be obtained.

FIG. 7 shows a second embodiment of a float according to the invention, where the duct 8 is a through-duct, i.e. it extends through the entire length of the first structural member 1 and opens to the lower end of the first structural member 1, whereby the float can be rigged with a fishing line running through the duct 8 in order to form a sliding float in a known way. The first structural member 1 further exhibits markings 21, which are arranged at the lower portion of the first structural member 1 in order to facilitate a correct adjustment of the buoyancy of the float. As shown in FIG. 7, these markings 21 can be constituted of protruding portions of the first structural member 1. Alternatively, the markings can be constituted of incisions into, or be painted onto, the surface of the first structural member 1.

The second embodiment of the float further includes a body 22, having a density being larger than the density of the structural members 1 and 10 and being arranged at the lower end of the first structural member 1 in order to ensure that the float assumes a substantially erect position in the water when the float is used. Thereby, the weight of the body 22 is adapted to the displacement range of the float, so that a desired buoyancy interval is obtained. The body 22 has a substantially circularly cylindrical shape and is arranged at the first structural member 1 by means of a threaded coupling. The body 22 exhibits an axial through-duct 23, constituting an extension of the duct 8 of the first structural member 1. The body 22 further exhibits a through-eye 24, enabling an alternative rigging of the fishing line in accordance with the first embodiment above.

Furthermore, the body 22 can be detached from the first structural member 1 in order to function as a conventional sliding sinker.

Preferably, the body 22 is made of metal, for example stainless steel. Alternatively, the body 22 can be made of another material having a large density, for example lead. However, for environmental reasons, lead should be avoided. Also other materials than metals can be used. The body 22 can be painted or surface-treated in another way, for example so that it obtains a reflecting surface, whereby the body 22, when being used as a sinker, can act as a lure for fish.

By means of the above-described design, a float is obtained which exhibits a large buoyancy interval in relation to the float size. The stabilizing volume makes the float relatively insensitive to wind and wave movements, and by means of the evacuating duct it is ensured that the float always obtains the same buoyancy at a given setting. It will be appreciated, however, that other designs are possible within the scope of the invention. For example, the float can include more than two structural members which are displaceable in relation to each other in order form the variable cavity. The structural members can be made of the same or different materials, having a density larger than or smaller than 1 g/cm³. Furthermore, the structural members can be made of composite materials.

1. A float, including at least two structural members (1, 10), enclosing a cavity (16) having a volume which is variable by means of a relative movement of the structural members (1, 10), said relative movement resulting in a change of the buoyancy of the float, characterized in that the float includes a volume (19) which is intended to be filled with water through an opening (20) when the float is immersed in water, as well as an evacuating duct through which air is intended to flow out of the volume (19) when the water flows in through the opening (20).

2. Float according to claim 1, characterized in that the evacuating duct extends from the upper end of the float to the upper portion of the volume (19).

3. Float according to claim 1, characterized in that the evacuating duct and the volume (19) are arranged substantially rotationally symmetrical around the symmetry axis of the float.

4. Float according to claim 1, characterized in that said relative movement includes a rotary motion of a first structural member (1) of said at least two structural members (1, 10) in relation to a second structural member (10) of said at least two structural members (1, 10).

5. Float according to claim 4, characterized in that the structural members (1, 10) are in threaded engagement with each other.

6. Float according to claim 1, characterized in that the float, at its lower end, includes a body (22) having a density being larger than the density of the structural members (1, 10).

7. Float according to claim 6, characterized in that the body (22) is detachable from the remainder of the float.

8. Float according to claim 1, characterized in that it includes markings (21) for adjustment of the buoyancy of the float.

9. Float according to claim 1, characterized in that the evacuating duct includes an axial duct (8), extending from the upper end of the float to the upper portion of said volume (19).

10. Float according to claim 9, characterized in that said axial duct (8) extends through the entire length of the float.
